(19) United States
(12) Patent Application Publication
(10) Pub. No.: US 2004/0031036 A1
(43) Pub. Date: Feb. 12, 2004

(54) Communication method

(76) Inventors: Clemens Dinges, Obermichelbach (DE); Joachim Feld, Nurnberg (DE); Ronald Lange, Furth (DE); Michael Schlereth, Wilhermsdorf (DE)

Correspondence Address: STAAS & HALSEY LLP, SUITE 700, 1201 NEW YORK AVENUE, N.W., WASHINGTON, DC, 20005, US

(21) Appl. No.: 10/451,250

(22) PCT Filed: Dec. 10, 2001
(86) PCT No.: PCT/DE01/04639

(30) Foreign Application Priority Data
Dec. 20, 2000 (DE) 10063700.0

(51) Int. Cl. G06F 9/00

(52) U.S. Cl. 719/310

(57) ABSTRACT

A computer requests information that is available in an automation system, coupled to the computer, concerning the system and the information is transmitted to the computer, or prepared for the latter by the automation system. In addition to the requested information, the automation system transmits data to the computer or prepares data for the latter, which provides a definition of the requested information.

The present invention relates to a communication method for an automation system having a computer which is coupled to the automation system, where the computer requests information about the automation system which is available in the automation system, the automation system transmitting the requested information to the computer or making it available thereto.

Such communication methods are known from U.S. Pat. No. 5,805,442 or from U.S. Pat. No. 6,061,603, for example.

In particular, by way of example, U.S. Pat. No. 6,061,603 gives a detailed description of a communication method between an automation system and a computer which involves the computer being able to be used to retrieve from the automation system a homepage, the configuration of the automation system, a block diagram of the controlled technical system and individual process variables.

The computer's communication with the automation system can prompt from many kinds of reactions a user of the computer. It is sometimes even possible to make adjustments to the automation system directly, e.g. to activate or deactivate parts of the automation system or to preset nominal variables again. It is therefore of great importance that the data transmitted from the automation system to the computer are interpreted correctly by the computer.

The object of the present invention is to provide a communication method for an automation system having a computer coupled to the automation system which provides the computer with a simple means of checking whether the data transmitted to it or made available to it are the desired data.

The object is achieved in that, in addition to the requested information, the automation system transmits or makes available to the computer data which describe the significance of the requested information.

The information can be of various kinds. By way of example, individual nominal or actual values or individual output variables can be requested. Alternatively, by way of example, the information can also be information about the automation system as such (how it is configured, whether it is in operation, whether and possibly which assemblies are faulty etc.). It is also possible for the information to comprise information about the technical system controlled by the automation system, particularly about the configuration of said technical system. In each of these cases, not only the information as such is transmitted but also, in addition to the requested information, data which describe the significance of the requested information.

If the requested information and the data are combined into information data pairs, it is particularly simple to associate information and data.

If the information data pairs are transmitted on the basis of a protocol for the worldwide web, such communication can be implemented by reverting to tried-and-tested standard methods. A suitable protocol is the HTTP protocol, in particular.

Even if the data and the information have been coded on the basis of a coding which is customary in the worldwide web, such communication can be implemented by reverting to tried-and-tested standard methods. Suitable protocols are the XML coding and the HTML coding, for example.

If the information also comprises configuration data about the automation system and/or a technical system, an overview of the automation system can be obtained using the computer in a particularly convenient manner.

Other advantages and details can be found in the description below of an exemplary embodiment in conjunction with the drawings, in which, in a basic illustration,

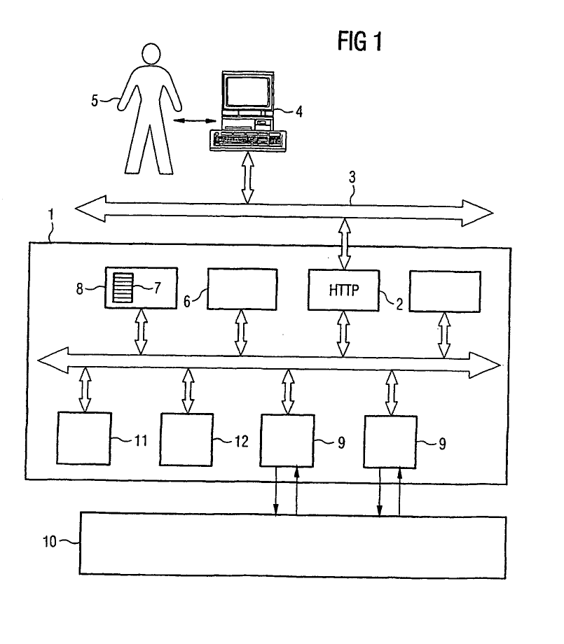

FIG. 1 shows an overview of a networked computer,

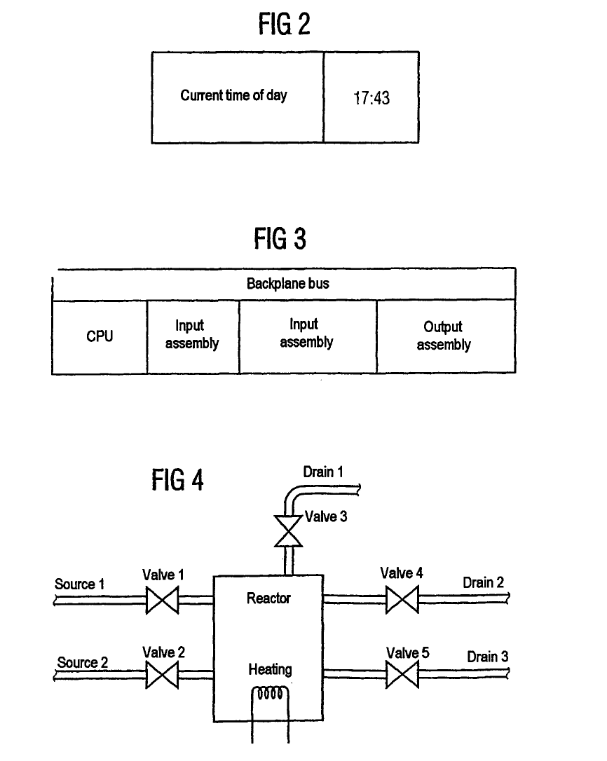

FIG. 2 shows an information data pair,

FIG. 3 shows a configuration for an automation system, and

FIG. 4 shows a configuration for a technical system.

In line with FIG. 1, an automation system 1 is connected to the worldwide web 3—shown in highly schematic form—via an interface 2. The worldwide web 3 also has a computer 4 connected to it which a user 5 can use to access the worldwide web 3. The computer 4 is thus coupled to the automation system 1 by means of the worldwide web 3. By virtue of the interface 2, the computer 4 can therefore be used to request information from the automation system 1 and to transmit messages, information and/or data to the automation system 1.

Internally, the automation system 1 has a processor unit 6 whose manner of operation is determined by a computer program product 7 stored in a read only memory 8, particularly in an electrically erasable read only memory (EEPROM) 8. The way in which the processor unit 6 works will be explained in more detail later.

The automation system 1 also has input/output units 9 which are used to control and monitor a technical system 10. To this end, inter alia, a process image store 11 stores an image of the input and output states of the input/output units 9 (process image). A configuration memory 12 also stores information about the system configuration and concordance information.

The system information allows a block diagram of the automation system 1 and/or of the technical system 10 to be created. The concordance information makes it possible to ascertain to which technological unit the individual memory locations provided in the process image store 11 for the process image correspond. If appropriate, this association can also be made beforehand so that it can be ascertained more quickly and, if appropriate, can be output via the interface 2.

Communication via the interface 2 is preferably performed on the basis of the HTTP protocol, as indicated in FIG. 1 by the corresponding label in the interface 2. The information data pairs themselves have been XML or HTML coded. Other protocols and codings for the worldwide web 3 are also suitable. A crucial factor is that a “markup” language is used. The interface 2 is thus always used not just for transmitting or providing the actually requested information, but rather packets containing information data pairs are transmitted. The data then describe the significance of the requested information.

The design described above, that is to say the paired grouping of information and corresponding data therefor, is observed for all transmitted data. The computer 4 is thus easily able to check the data and the consistency thereof. Alterations to the data, e.g. changes to the configurations in corresponding tools, are also possible.

In order to be able to make such changes in an appropriate manner, the configuration memory 12 in the automation system 1 also stores, inter alia, the configuration data about the automation system 1 and the configuration data about the technical system 10. These data can also be transmitted or made available to the computer 4. The computer 4 is thus also able to display the configurations of the automation system 1 or of the technical system 10 which are shown by way of example in FIGS. 3 and 4. For such requests too, in addition to the requested information as such, data describing the significance of the requested information are transmitted or made available to the computer. It is therefore possible to access the automation system 1 using a generic browser or a generic tool. On the basis of the transmitted information and data, the browser or the tool then adapts itself to the automation system 1. If appropriate, namely in the event of changes, it is also possible to transmit the respective data and information back to the automation system 1 and to store them in the configuration memory 12.

1. A communication method for an automation system (1) having a computer (4) which is coupled to the automation system (1), where the computer (4) requests information about the automation system (1) which is available in the automation system (1), the automation system (1) transmitting the requested information to the computer (4) or making it available thereto,
characterized
in that, in addition to the requested information, the automation system (1) transmits or makes available to the computer (4) data which describe the significance of the requested information.

2. The communication method as claimed in claim 1,
characterized
in that the requested information and the data are combined into information data pairs.

3. The communication method as claimed in claim 2,
characterized
in that the information data pairs are transmitted on the basis of a protocol for the worldwide web.

4. The communication method as claimed in claim 3,
characterized
in that the protocol is the HTTP protocol.

5. The communication method as claimed in one of the above claims,
characterized
in that the information and the data have been coded using a coding which is customary in the worldwide web.

6. The communication method as claimed in claim 5,
characterized
in that the protocol is the XML protocol.

7. The communication method as claimed in claim 5,
characterized
in that the protocol is the HTML protocol.

8. The communication method as claimed in one of the above claims,
characterized
in that the information also comprises configuration data about the automation system (1) and/or a technical system (10).

9. A computer program product for an automation system (1) for carrying out a communication method as claimed in one of the above claims.

10. An automation system,
characterized
in that it has been programmed using a computer program product (7) as claimed in claim 9.
